(19) United States
(12) Patent Application Publication
(10) Pub. No.: US 2025/0281339 A1
(43) Pub. Date: Sep. 11, 2025

(54) WHEELCHAIR TRANSPORT CARRIER

(71) Applicant: Brady Larkin, Fargo, ND (US)

(72) Inventor: Brady Larkin, Fargo, ND (US)

(21) Appl. No.: 19/060,685

(22) Filed: Feb. 22, 2025

Related U.S. Application Data
(60) Provisional application No. 63/562,163, filed on Mar. 6, 2024.

(51) Int. Cl. A61G 3/06; A61G 3/08; B62B 1/22; B62B 5/06

(52) U.S. Cl. CPC A61G 3/061; A61G 3/0808; B62B 1/22; B62B 5/067; B62B 2202/90

(57) ABSTRACT

A wheelchair transport carrier and method. In an embodiment, a wheelchair transport carrier comprises a main frame comprising a support platform defining a wheelchair support surface to support wheels of a wheelchair, a plurality of lift handles to lift the main frame, and a plurality of restraints to anchor the wheelchair to the support platform.

### RELATED APPLICATIONS

This non-provisional application claims priority to U.S. provisional application 63/562,163, filed on Mar. 6, 2024, which is incorporated herein by reference as if fully provided herein.

### FIELD

This disclosure is related to the field of wheelchairs, and more particularly, to transport of wheelchairs.

### BACKGROUND

People who cannot walk or have difficulty walking may use a wheelchair as a means of mobility. A problem may arise when traveling, such as on an airline, as the wheelchair may be damaged due to improper handling by airline personnel, improper storage during transport, etc. For example, electric or powered wheelchairs may be hundreds of pounds, and are difficult to lift onto conveyors, into cargo holds, etc. Thus, the wheelchair may tip over, fall from an elevated surface (e.g., conveyor), or otherwise be damaged. Further, there is no clear indication where it is safe to lift some types of wheelchairs, which results in armrests and/or other components being damaging during lifting. Damage to a wheelchair is not only inconvenient to the owner, but may be their only means of mobility at their destination. Further, airlines and/or other types of public or private transport organizations are typically liable for repair or replacement of damaged wheelchairs.

### SUMMARY

The present embodiments describe a transport carrier for wheelchairs. Although the description below may focus on wheelchairs, the transport carrier may be used for scooters and/or other types of conveyances. In general, the transport carrier comprises a support platform that supports the wheels of the wheelchair, and a plurality of restraints that anchor the wheelchair to the support platform. The transport carrier further comprises a plurality of lift handles comprising lift points for the transport carrier. When loaded on the transport carrier and restrained, the wheelchair may be properly handled and stored during transport to avoid damage to the wheelchair. One technical benefit is people with disabilities or that otherwise use a wheelchair feel freer to travel without worry of their wheelchair being damaged. Another technical benefit is airlines and/or other organizations can avoid liabilities associated with damaged wheelchairs.

In an embodiment, a wheelchair transport carrier comprises a main frame comprising a support platform defining a wheelchair support surface to support wheels of a wheelchair, a plurality of lift handles to lift the main frame, and a plurality of restraints to anchor the wheelchair to the support platform.

In an embodiment, a wheelchair transport carrier comprises a main frame comprising a support platform defining a wheelchair support surface to support wheels of a wheelchair, a ramp at a loading end of the main frame configured to rotate in relation to the main frame between a raised position and a lowered position, a plurality of restraints to anchor the wheelchair to the support platform, and a plurality of lift handles rotatably coupled to the main frame to transition between a stowed position and an open position.

In an embodiment, a method comprises obtaining a wheelchair transport carrier, lowering the ramp to the lowered position, loading the wheelchair on the wheelchair support surface via the ramp, restraining the wheelchair to the main frame via one or more restraints, raising the ramp to the raised position, opening the lift handles to the open position, and lifting the wheelchair transport carrier via the lift handles with the wheelchair restrained.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments are now described, by way of example only, and with reference to the accompanying drawings. The same reference number represents the same element or the same type of element on all drawings.

FIGS. 1-4 are perspective views of a wheelchair transport carrier in illustrative embodiments.

FIG. 5 is a flow chart illustrating a method of using a wheelchair transport carrier in an illustrative embodiment.

FIGS. 6-7 are perspective views of a wheelchair transport carrier in an illustrative embodiment.

FIG. 8 is a plan view of a wheelchair transport carrier in an illustrative embodiment.

FIG. 9 is a side view of a wheelchair transport carrier in an illustrative embodiment.

FIG. 10 is an end view of a wheelchair transport carrier in an illustrative embodiment.

FIG. 11 is an end view of a wheelchair transport carrier in an illustrative embodiment.

FIGS. 12A-12B are perspective views of a wheelchair transport carrier in an illustrative embodiment.

FIG. 13 illustrates a ramp latch in an illustrative embodiment.

FIG. 14 illustrates a wheelchair loaded onto a wheelchair transport carrier.

FIG. 15 is a plan view of a wheelchair transport carrier in an illustrative embodiment.

FIG. 16 illustrates a restraint in an illustrative embodiment.

FIGS. 17A-17F illustrate a lift handle in illustrative embodiments.

FIG. 18 is a perspective view of a wheelchair transport carrier in an illustrative embodiment.

FIGS. 19A-19B are flow charts illustrating a method of using a wheelchair transport carrier in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

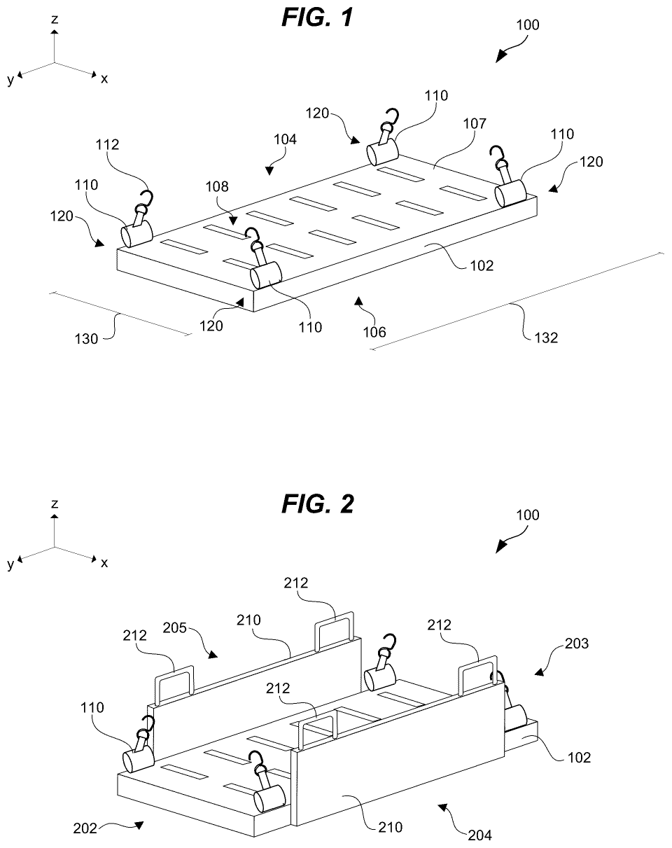

FIG. 1 is a perspective view of a wheelchair transport carrier 100 in an illustrative embodiment. FIG. 1 is not drawn to scale. Wheelchair transport carrier 100 comprises an apparatus, equipment, or other structure configured to secure a wheelchair during transport, such as on an airline. In an embodiment, wheelchair transport carrier 100 includes a main frame 102 having a top side 104 and an opposing bottom side 106 (also referred to as an undercarriage). Main frame 102 may be made from a rigid material, such as aluminum, carbon fiber, or another material. Top side 104 of main frame 102 comprises a support platform 107 that defines a wheelchair support surface 108 configured to support wheels of a wheelchair (not shown). In an embodiment, wheelchair support surface 108 forms a generally flat or planar surface upon which wheels of a wheelchair may be loaded.

In an embodiment, main frame 102 may be a rectangular or elongated member having a length 132 (e.g., in the y-direction) and a width 130 (e.g., in the x-direction). The dimensions of wheelchair transport carrier 100 may be configured to fit within the door of a cargo hold of an aircraft or another transportation vehicle. For example, the width 130 of wheelchair transport carrier 100 may be less than about 30 inches, less than about 31 inches, less than about 32 inches, less than about 36 inches, etc., the length 132 of wheelchair transport carrier 100 may be less than about 48 inches, less than about 50 inches, etc.

On or proximate to wheelchair support surface 108 of main frame 102, wheelchair transport carrier 100 comprises a plurality of restraints 110 configured to anchor the wheelchair to the support platform 107 of main frame 102. Main frame 102 may comprise a plurality of anchor points 120 where restraints 110 are affixed or attached to main frame 102. In an embodiment, restraints 110 may comprise automatic retractable tie-downs, such as Q-straints. The restraints 110 may include a hook end 112 configured to attach to the wheelchair, and an anchor end that is affixed or attached to an anchor point 120 of main frame 102. One technical benefit is a wheelchair may be securely attached to wheelchair transport carrier 100 during transport.

FIG. 2 is a perspective view of wheelchair transport carrier 100 in an illustrative embodiment. FIG. 2 is not drawn to scale. Wheelchair transport carrier 100 further comprises a plurality of lift handles 212 configured to lift the main frame 102. As shown in FIG. 2, main frame 102 comprises opposing ends 202-203, and opposing sides 204-205. Sides 204-205 of main frame 102 may include raised side panels 210 that are raised or elevated in relation to the wheelchair support surface 108. Lift handles 212 may be disposed on or at side panels 210 of main frame 102 to provide a lifting point for wheelchair transport carrier 100. However, the lift handles 212 may be disposed at other locations on main frame 102 in other embodiments. In an embodiment, lift handles 212 may be extendible or retractable, foldable, etc. One technical benefit is the lift handles 212 provide safe locations from which to lift or move the wheelchair transport carrier 100. Thus, a restrained wheelchair does not need to be contacted or handled when lifting or moving the wheelchair transport carrier 100.

FIG. 3 is a perspective view of wheelchair transport carrier 100 in an illustrative embodiment. In an embodiment, wheelchair transport carrier 100 may further comprise a ramp 302 disposed at an end 202 of the main frame 102, which may be referred to as a loading end. Ramp 302 is configured to facilitate loading of a wheelchair onto wheelchair support surface 108 at loading end 202. In an embodiment, ramp 302 may be retractable, foldable, etc. One technical benefit is a wheelchair may be safely loaded onto wheelchair transport carrier 100, without having to physically lift the wheelchair itself.

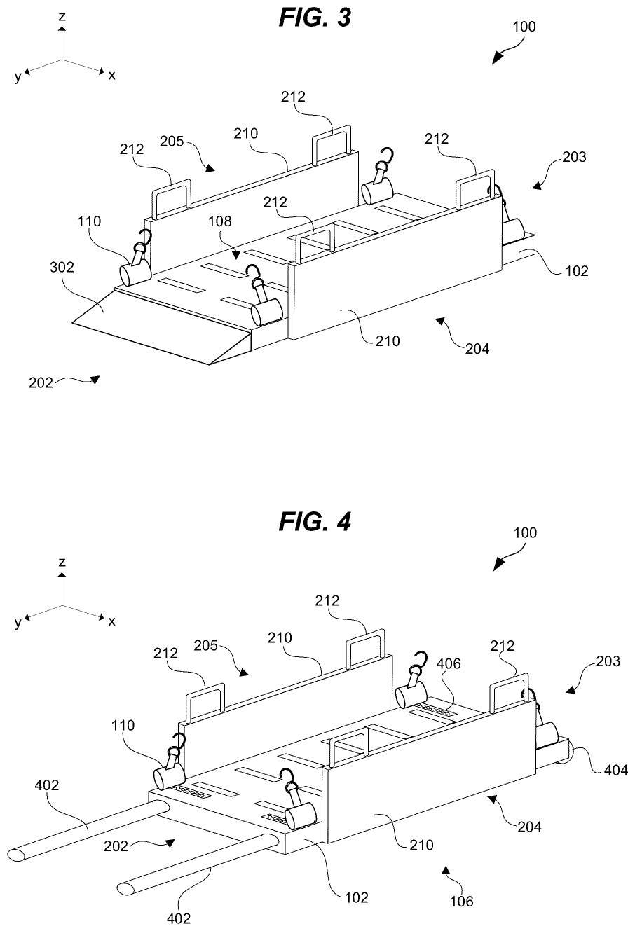

FIG. 4 is a perspective view of wheelchair transport carrier 100 in an illustrative embodiment. In an embodiment, wheelchair transport carrier 100 may further comprise one or more wheels 404 or rollers mounted on bottom side 106 of main frame 102 toward end 203. Wheelchair transport carrier 100 may further comprise one or more pull handles 402 mounted toward end 202 of main frame 102 opposite end 203. Pull handles 402 are configured to pull or drag wheelchair transport carrier 100 on wheels 404 along a ground surface. In an embodiment, pull handles 402 may be retractable, foldable, etc. One technical benefit is the portability of the wheelchair transport carrier 100 is enhanced or improved.

In an embodiment, anchor points 120 may comprise L-track rails 406 or another type of track system configured to adjust the positions/locations of restraints 110. One technical benefit is the positions/locations of restraints 110 are adjustable to accommodate different wheelchairs.

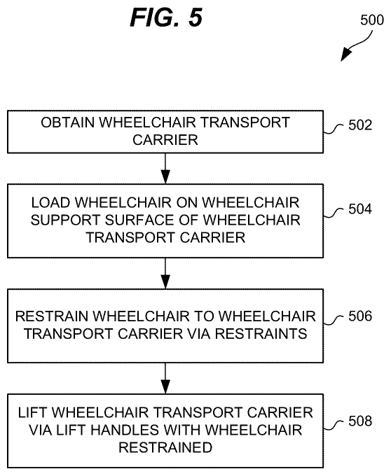

FIG. 5 is a flow chart illustrating a method 500 of using a wheelchair transport carrier 100 in an illustrative embodiment. The steps of the flow charts described herein are not all inclusive and may include other steps not shown, and the steps may be performed in an alternative order. For method 500, a wheelchair transport carrier 100 is obtained (step 502), such as described above. A wheelchair is loaded on the wheelchair support surface 108 of the wheelchair transport carrier 100 (step 504), such as via a ramp 302. The wheelchair is restrained or anchored to the wheelchair transport carrier 100 via the restraints 110 (step 506). The wheelchair transport carrier 100 may then be lifted via the lift handles 212 with the wheelchair restrained (step 508), such as onto an aircraft, onto a conveyor, etc. One technical benefit is a wheelchair may be protected from damage during transport, such as on an aircraft.

Although specific embodiments were shown above, wheelchair transport carrier 100 may include further structures or features that assist in the transport of a wheelchair, assist in loading a wheelchair, assisting in lifting the wheelchair transport carrier 100 with a wheelchair restrained, etc. In the following examples, additional or alternative structures or features may be described in the context of a wheelchair transport carrier, which provide similar benefits as described above. These examples may be incorporated in embodiments described above as desired.

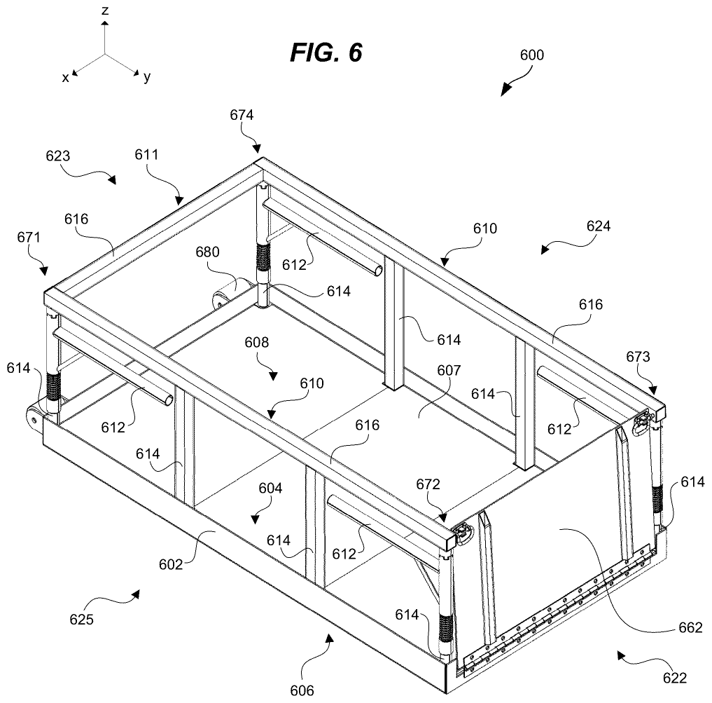

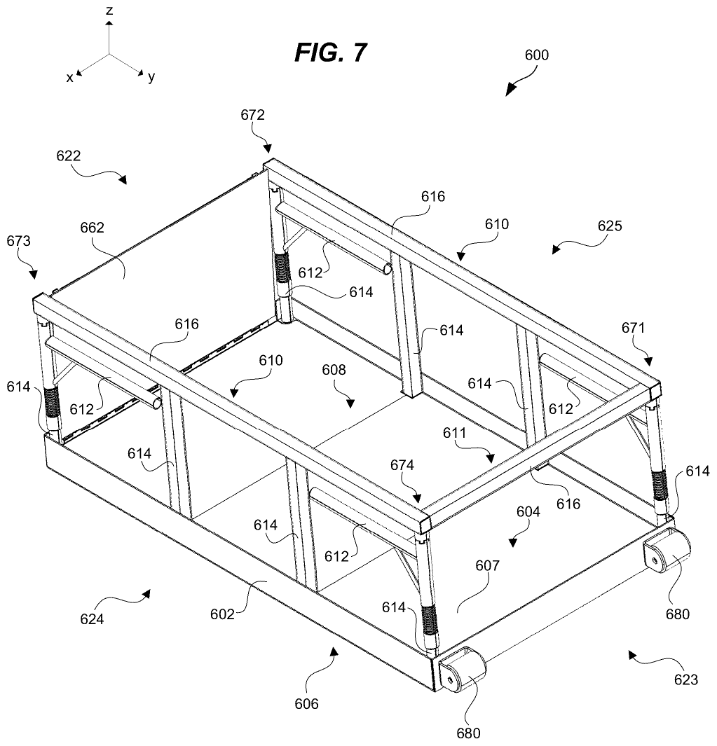

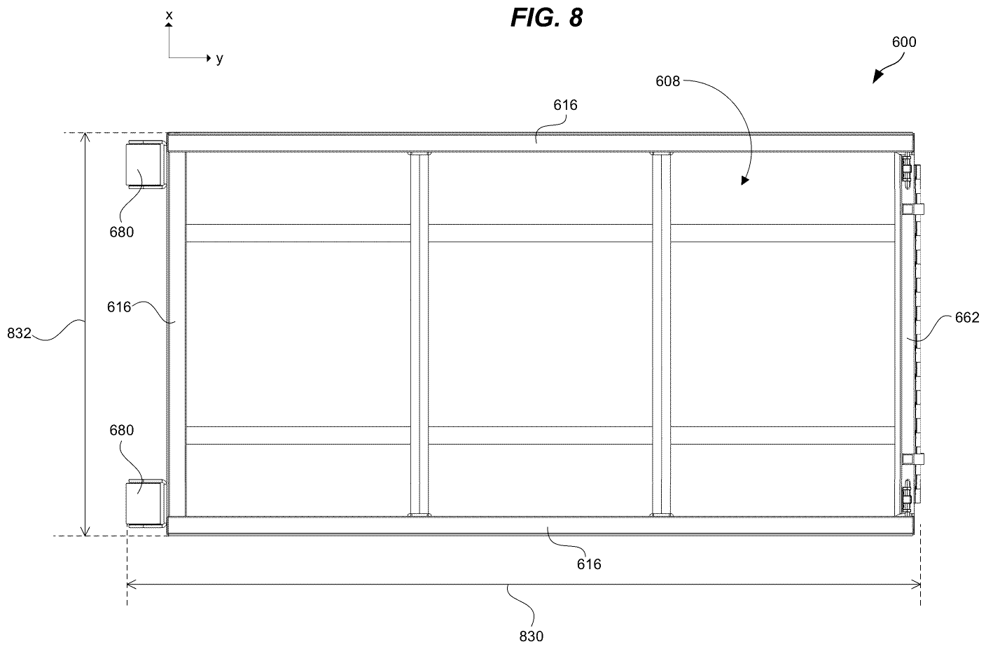

FIGS. 6-7 are perspective views of a wheelchair transport carrier 600 in an illustrative embodiment. In an embodiment, wheelchair transport carrier 600 includes a main frame 602 made from a rigid material, such as aluminum, carbon fiber, and/or other materials. Main frame 602 comprises a support platform 607 having a top side 604 and an opposing bottom side 606 (also referred to as an undercarriage). Top side 604 of support platform 607 comprises or defines a wheelchair support surface 608 configured to support wheels of a wheelchair (not shown). In an embodiment, wheelchair support surface 608 forms a generally flat or planar surface upon which wheels of a wheelchair may be loaded. The bottom side 606 (or at least a portion thereof) is configured to rest on a support surface, such as the ground, a floor, etc.

FIG. 8 is a plan view of wheelchair transport carrier 600 in an illustrative embodiment. In an embodiment, wheelchair transport carrier 600/main frame 602/support platform 607 may be a rectangular or elongated member having a length 830 (e.g., in the y-direction) and a width 832 (e.g., in the x-direction). The dimensions of wheelchair transport carrier 600 may be configured to fit within the door of a cargo hold of an aircraft or another transportation vehicle. For example, the width 832 of wheelchair transport carrier 600 may be less than about 30 inches, less than about 31 inches, less than about 32 inches, less than about 36 inches, etc., the length 830 of wheelchair transport carrier 600 may be less than about 48 inches, less than about 50 inches, etc.

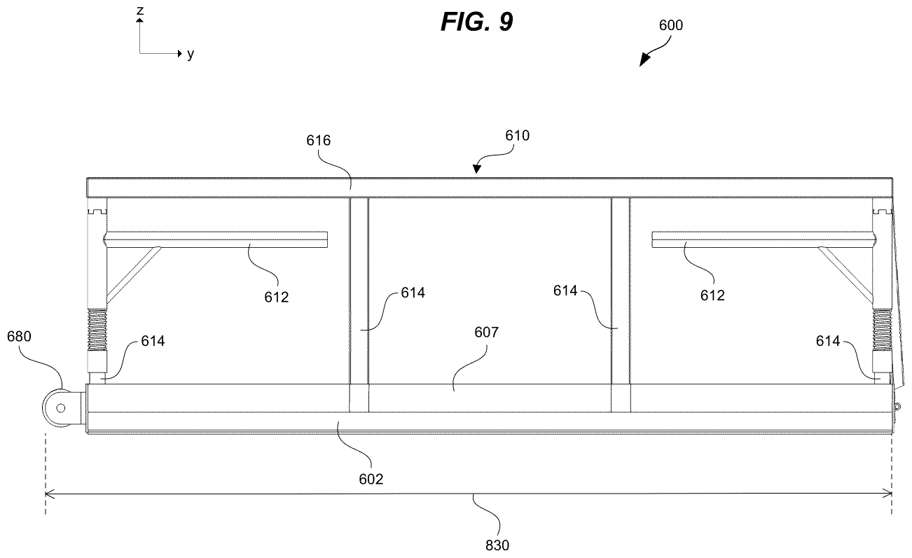

In FIGS. 6-7, main frame 602 may further comprise side rails 610 (also referred to as side panels) connected or affixed to support platform 607. Main frame 602 comprises opposing ends 622-623, and opposing sides 624-625. Side rails 610 are connected or affixed to support platform 607 at sides 624-625, such as by bolts or other fastening devices, welds, etc., and are raised or elevated in relation to the wheelchair support surface 608. FIG. 9 is a side view of wheelchair transport carrier 600 in an illustrative embodiment. In an embodiment, side rails 610 may comprise one or more horizonal rail members 616 that span at least a portion of the length 830 of the main frame 602. The side rails 610 may further comprise a plurality of vertical rail members 614 that connect the horizonal rail member(s) 616 to the support platform 607. The vertical rail members 614 may be referred to as support posts, support bars, stanchions, etc. One or more of vertical rail members 614 may be perpendicular to the plane of wheelchair support surface 608. Although the term “vertical” is used to describe rail members 614, one or more of the vertical rail members 614 may be angled in relation to the plane of wheelchair support surface 608. The horizonal rail member(s) 616 and vertical rail members 614 may comprise square or rectangular tubing (e.g., hollow), cylindrical tubing, etc.

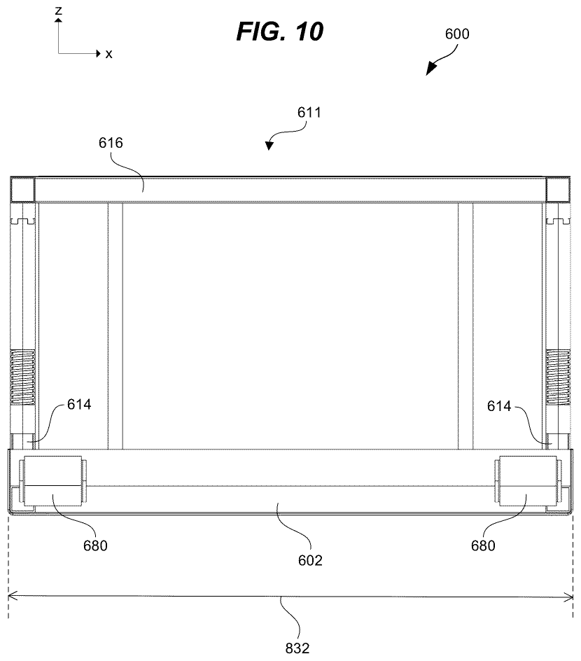

In FIGS. 6-7, wheelchair transport carrier 600 may further comprise an end rail 611 (also referred to as an end panel) connected or affixed to support platform 607 and/or side rails 610. End rail 611 is connected or affixed at end 623, such as by bolts or other fastening devices, welds, etc. FIG. 10 is an end view of wheelchair transport carrier 600 in an illustrative embodiment. In an embodiment, end rail 611 may comprise one or more horizonal rail members 616 that span at least a portion of the width 832 of the main frame 602. The horizonal rail member 616 of end rail 611 may be connected or affixed to horizonal rail members 616 of side rails 610. In other embodiments, end rail 611 may connect to support platform 607 through one or more vertical rail members 614. One technical benefit is side rails 610 and/or end rail 611 surround the wheelchair support surface 608 on sides 624-625 and end 623 to form an enclosure that may further protect a restrained wheelchair.

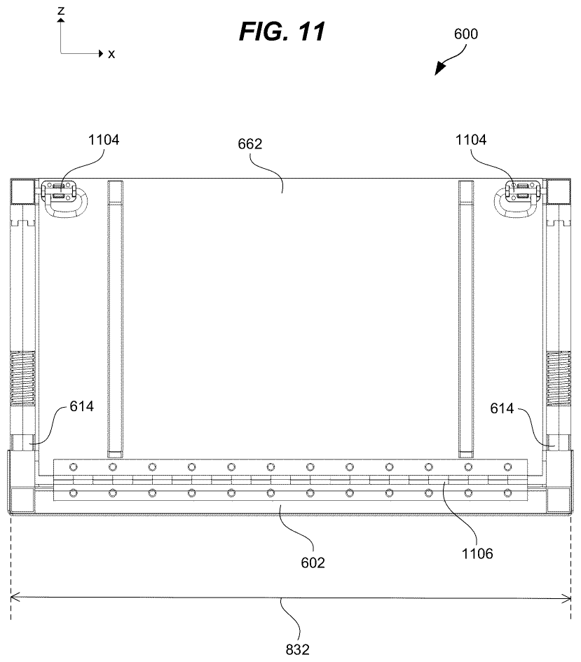

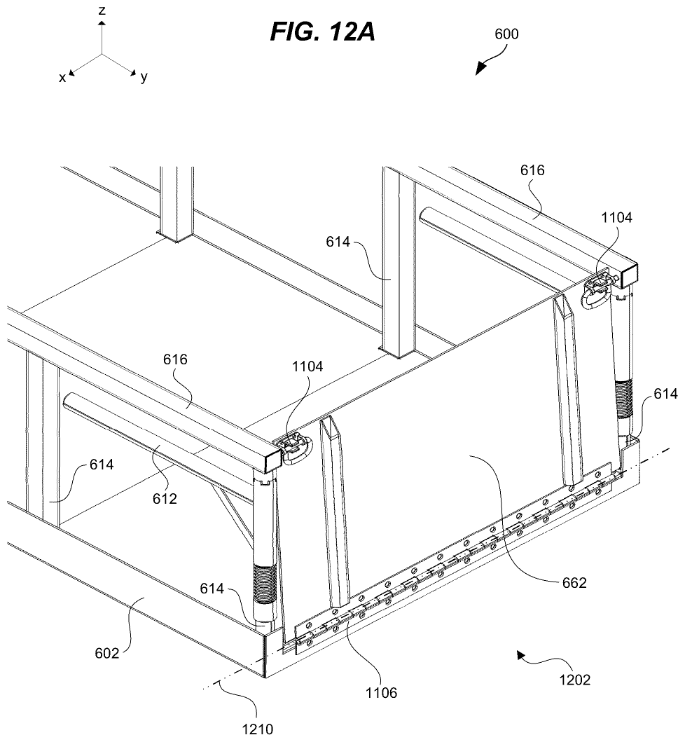

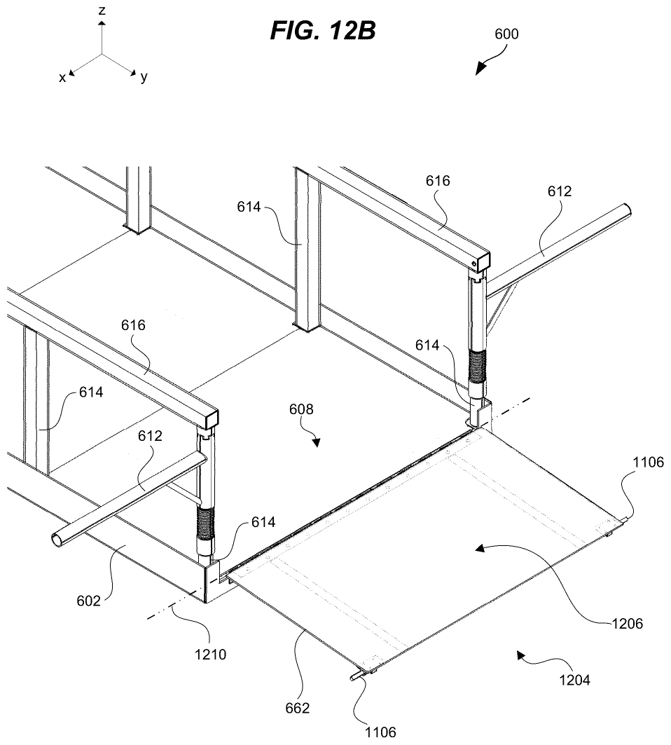

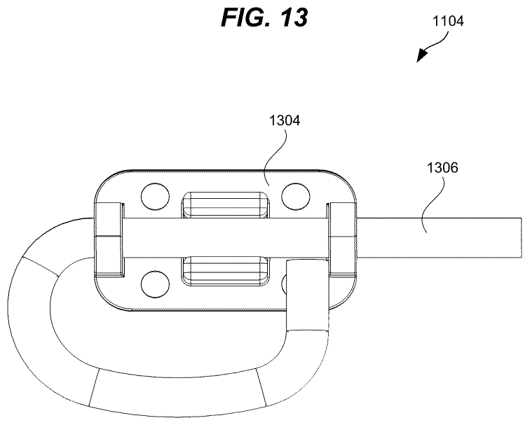

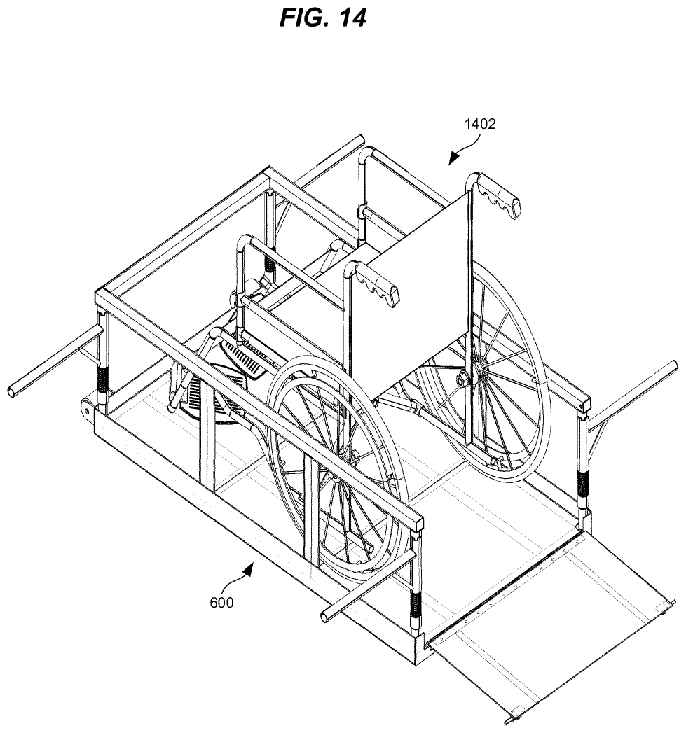

In an embodiment, wheelchair transport carrier 600 may further comprise one or more wheels 680 or rollers mounted on support platform 607 toward end 623. One technical benefit is the portability of the wheelchair transport carrier 600 is enhanced or improved. In an embodiment, wheelchair transport carrier 600 may further comprise a ramp 662 disposed at end 622 of the main frame 602, which may be referred to as a loading end, as illustrated in FIGS. 6-7. Ramp 662 is configured to facilitate loading of a wheelchair onto wheelchair support surface 608 of main frame 602 at loading end 622. FIG. 11 is an end view of wheelchair transport carrier 600 in an illustrative embodiment. FIGS. 12A-12B are perspective views of wheelchair transport carrier 600 in an illustrative embodiment. Ramp 662 is attached or affixed to main frame 602 (e.g., support platform 607) at end 622 via a ramp hinge 1106. Ramp hinge 1106 allows ramp 662 to rotate or pivot in relation to main frame 602 about a rotation axis 1210 (see FIGS. 12A-12B), which is generally a horizontal axis. Ramp 662 is configured to rotate via ramp hinge 1106, and transition between a closed position 1202 (or closed configuration, raised position, etc.) as shown in FIG. 12A, and an open position 1204 (or open/loading configuration, lowered position, etc.) as shown in FIG. 12B. When in the closed position 1202, the ramp 662 may be approximately vertical in relation to the ground, the wheelchair support surface 608, etc. Wheelchair transport carrier 600 may comprise one or more ramp latches 1104 configured to lock or secure the ramp 662 in the closed position 1202. FIG. 13 illustrates a ramp latch 1104 in an illustrative embodiment. The ramp latch 1104 may comprise a slide bolt latch 1304 (or slide bolt lock). Slide bolt latch 1304 includes a (e.g., metal) bolt 1306 or barrel configured to slide into a receptacle or strike plate on main frame 602, such as on a horizonal rail member 616, a vertical rail member 614, etc.

FIG. 12B illustrates the ramp 662 in an open position 1204. The inner surface 1206 of ramp 662 may be a generally flat or planar surface that is inclined from a ground surface to the wheelchair support surface 608. This allows for a wheelchair to roll from the ground surface, up the ramp 662, and onto the wheelchair support surface 608. FIG. 14 illustrates a wheelchair 1402 loaded onto wheelchair transport carrier 600. Although a non-electric wheelchair is illustrated in FIG. 14 merely as an example, wheelchair transport carrier 600 may be used for transport of electric wheelchairs or other electric conveyances that are relatively heavy.

Although ramp 662 is shown as being foldable in the above embodiment, ramp 662 may be retractable in other embodiments. One technical benefit is a wheelchair 1402 may be safely loaded onto wheelchair transport carrier 600, without having to physically lift the wheelchair 1402 itself.

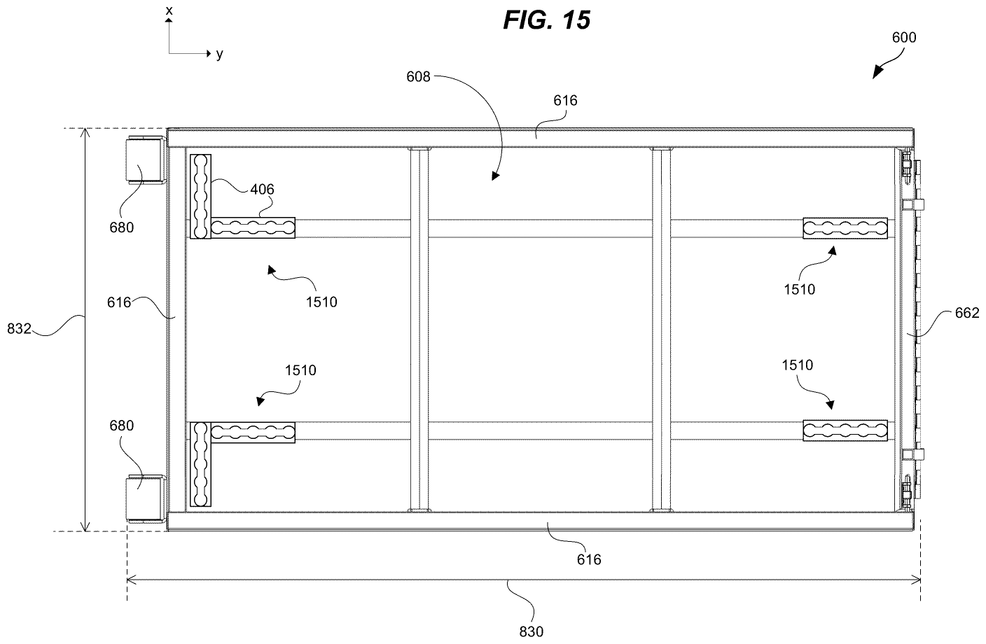

With a wheelchair 1402 loaded onto wheelchair transport carrier 600, the wheelchair 1402 may be restrained onto wheelchair transport carrier 600. FIG. 15 is a plan view of wheelchair transport carrier 600 in an illustrative embodiment. Wheelchair transport carrier 600 may comprise a plurality of anchor points 1510 where restraints are affixed or attached to main frame 602. The restraints are configured to anchor the wheelchair 1402 to the main frame 602. For example, anchor points 1510 may be positioned at or near corners of wheelchair support surface 608. In an embodiment, anchor points 1510 may comprise L-track rails 406 or another type of track system configured to adjust the positions/locations of the restraints. One technical benefit is the positions/locations of restraints are adjustable to accommodate different wheelchairs 1402.

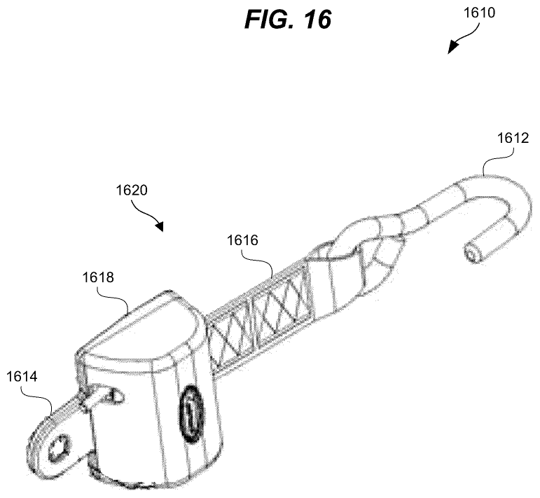

FIG. 16 illustrates a restraint 1610 in an illustrative embodiment. In an embodiment, a restraint 1610 may include a hook end 1612 configured to attach to a wheelchair 1402, and an anchor end 1614 that is affixed or attached to an anchor point 1510 of main frame 602. For example, the anchor end 1614 may be attached to an L-track rail 406 installed on wheelchair support surface 608. Restraint 1610 further includes a strap 1616 and a tensioner mechanism 1618 (e.g., automatic tensioner) between the hook end 1612 and the anchor end 1614. Restraint 1610 may be referred to as an automatic retractable tie-down 1620, one example of which is a Q-straint. One technical benefit is a wheelchair 1402 may securely attached to wheelchair transport carrier 600 during transport.

In FIGS. 6-7, wheelchair transport carrier 600 further comprises a plurality of lift handles 612. Lift handles 612 are structural elements configured to provide lift points to lift the main frame 602. Lift handles 612 may be disposed at the sides 624-625 and/or corners 671-674 of main frame 602. Although four lift handles 612 are illustrated, there may be more or less lift handles 612 in other embodiments. One technical benefit is the lift handles 612 provide safe locations from which to lift or move the wheelchair transport carrier 600. Thus, a restrained wheelchair 1402 does not need to be contacted or handled when lifting or moving the wheelchair transport carrier 600.

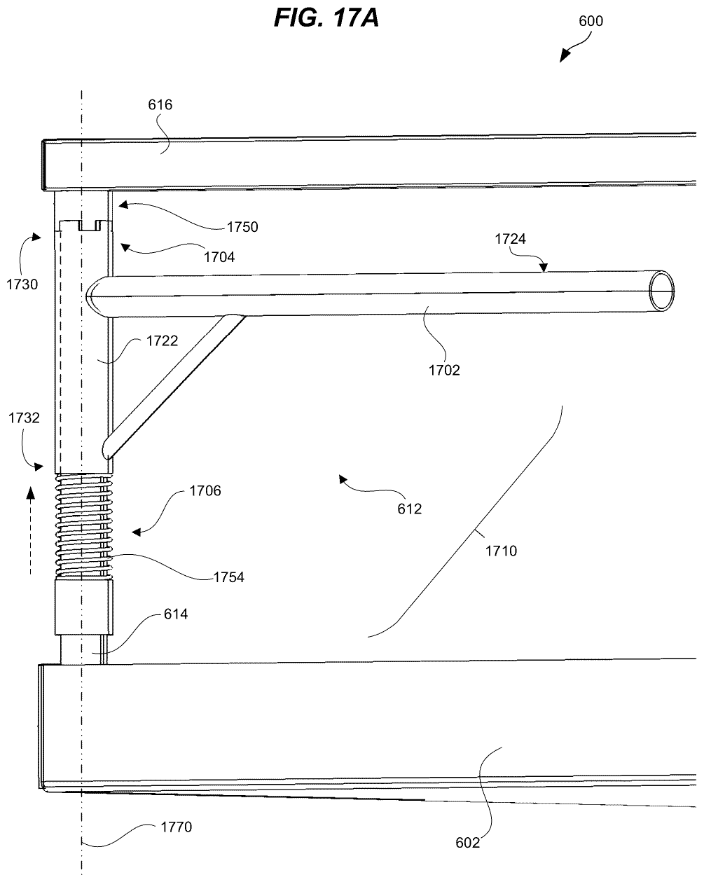

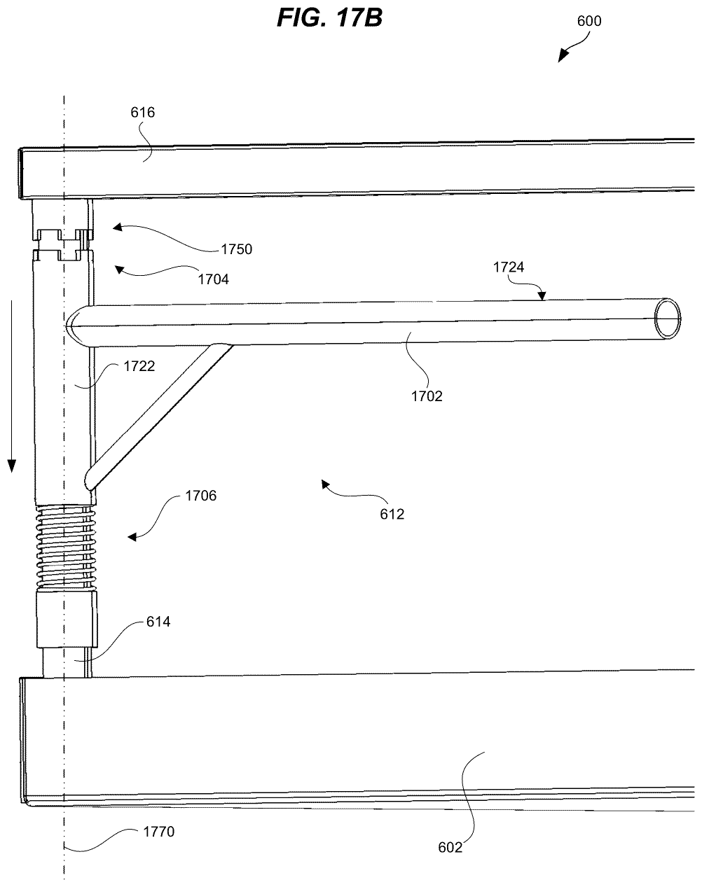

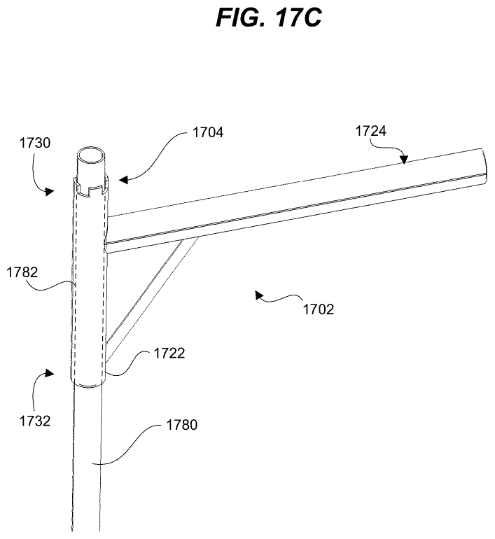

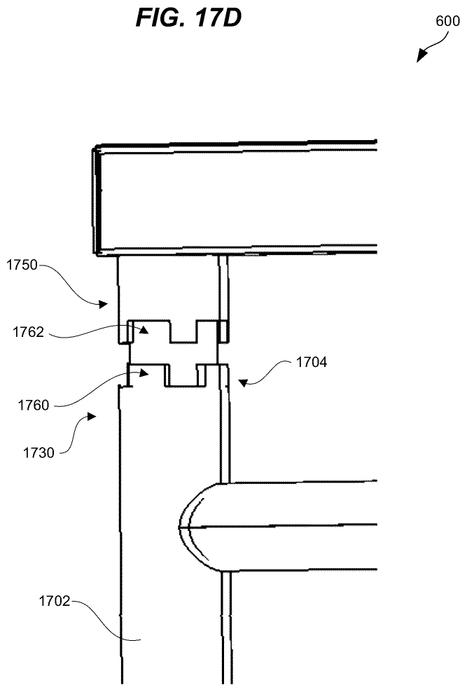

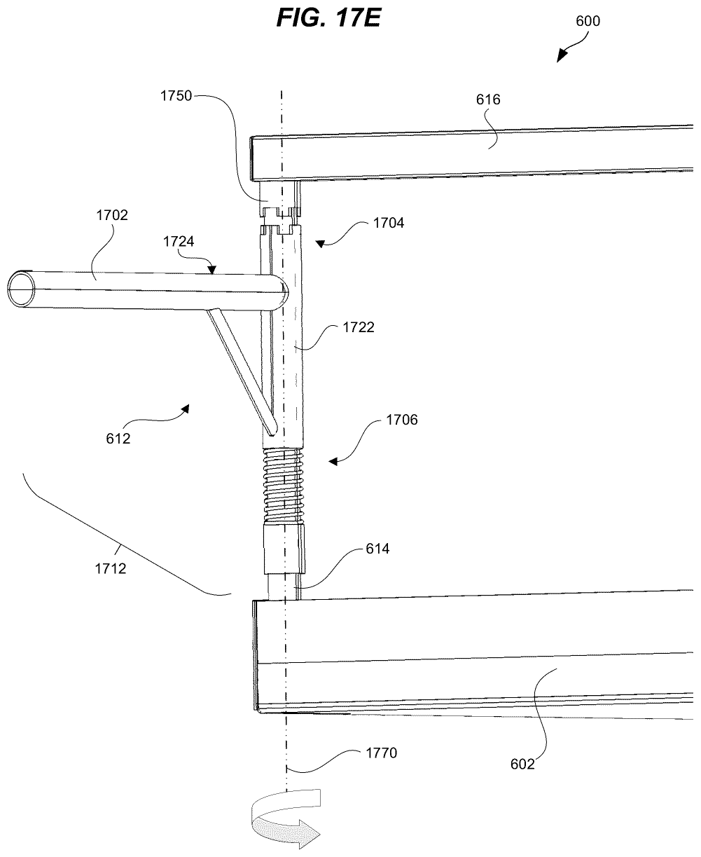

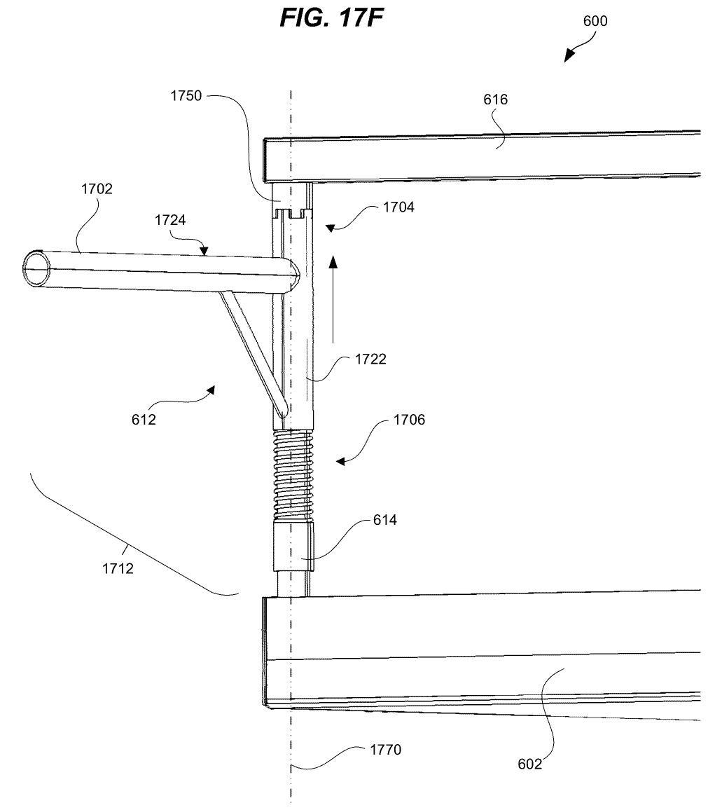

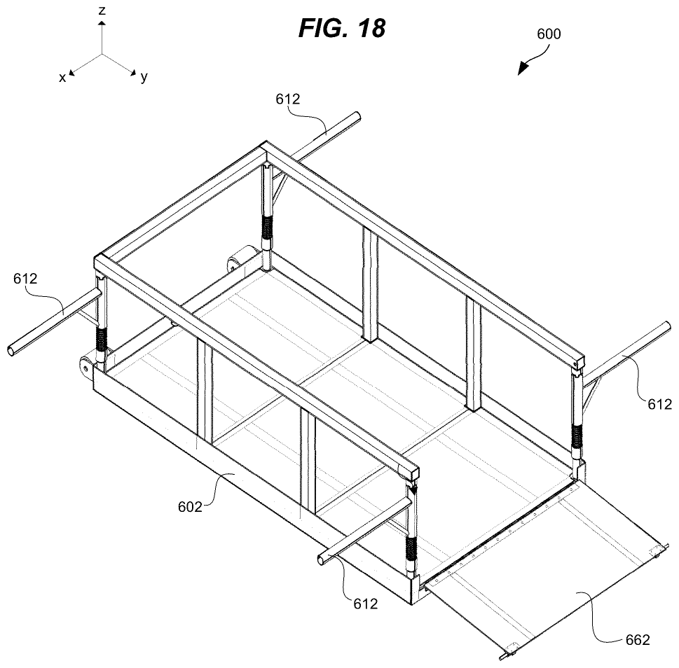

FIGS. 17A-17F illustrate a lift handle 612 in illustrative embodiments. In an embodiment, a lift handle 612 may be rotatably or pivotally coupled to main frame 602 to transition between a closed position 1710 (see FIG. 17A) and an open position 1712 (see FIG. 17F). In an embodiment, a lift handle 612 may be rotatably or pivotally coupled to main frame 602. As in FIG. 17A, a vertical rail member 614 may comprise a round tube, and lift handle 612 may be configured to slide over the vertical rail member 614 and rotate in relation to the vertical rail member 614 about a rotation axis 1770, which may be generally a vertical axis. A lift handle 612 may comprise a handle member 1702, a rotation locking mechanism 1704 (also referred to as rotation locking member), and a biasing member 1706. Handle member 1702 is configured to rotate about rotation axis 1770 between a closed position 1710 (also referred to as stowed or retracted position, a closed configuration, etc.) as shown in FIG. 17A, and an open position 1712 (also referred to as an extended position or lifting position, an open configuration, etc.) as shown in FIG. 17F. Rotation locking mechanism 1704 is configured to prevent rotation of the handle member 1702. For example, rotation locking mechanism 1704 is configured to engage a corresponding rotation locking mechanism 1750 (also referred to as rotation locking member) of main frame 602 to lock or secure the handle member 1702 in the closed position 1710 or the open position 1712. Biasing member 1706, such as a compression spring 1754, is configured to bias the handle member 1702 axially (e.g., upward in FIG. 17A) to be in one of the closed position 1710 or the open position 1712. In other words, the biasing member 1706 is configured to apply a biasing force (indicated by dashed arrow) to engage rotation locking mechanism 1704 of handle member 1702 with the corresponding rotation locking mechanism 1750 of main frame 602. One technical benefit is the handle member 1702 may be selectively repositioned between the closed position 1710 and the open position 1712, and held in the selected position.

In an embodiment, the handle member 1702 may comprise a round tube 1722 and a grip member 1724. Grip member 1724 may comprise a round tube, a square tube, or some other element configured to be grasped by a human hand. Grip member 1724 extends radially outward from round tube 1722 (e.g., forming approximately a 90-degree angle). Round tube 1722 is an elongated member have a first end 1730 and an opposing second end 1732. Round tube 1722 is configured to slide over a round or cylindrical support member (e.g., vertical rail member 614) of main frame 602, and rotate in relation to that support member. The first end 1730 of round tube 1722 includes rotation locking mechanism 1704, and the second end 1732 of round tube 1722 is configured to engage or abut biasing member 1706 (or an intervening member, such as a spacer, bushing, etc.). In FIG. 17C, for example, the round tube 1722 of handle member 1702 comprises a hollow cylinder 1782 having a diameter larger (e.g., slightly) than the diameter of a (e.g., vertical) support member 1780 of the main frame 602. As described above, support member 1780 may comprise a vertical rail member 614, but other types of support members are considered herein. The support member 1780 of main frame 602 may be rotatably fitted into the hollow cylinder 1782 of handle member 1702. Thus, the round tube 1722 of handle member 1702 and the cylindrical support member 1780 are concentric. In other embodiments, the handle member 1702 may be rotatably fitted into a hollow cylinder of support member 1780, as an example. Although not shown, a bushing, bearing, etc., may be disposed between the round tube 1722 of handle member 1702 and the cylindrical support member 1780. One technical benefit is this configuration allows the handle member 1702 to rotate or pivot in relation to the main frame 602.

To transition from the closed position 1710 as in FIG. 17A to the open position 1712 as in FIG. 17F, handle member 1702 slides or translates axially against the biasing force applied by the biasing member 1706, such as shown in FIG. 17B. This disengages the rotation locking mechanism 1704 of handle member 1702 from the rotation locking mechanism 1750 of main frame 602. When disengaged, handle member 1702 is free to rotate in relation to the vertical rail member 614 about rotation axis 1770.

FIG. 17D is a magnified view of rotation locking mechanism 1704. Rotation locking mechanism 1704 may include one or more engagement members 1760 (e.g., a projection(s), notch(es), groove(s), etc.) configured to engage with corresponding engagement members 1762 (e.g., a projection(s), notch(es), groove(s), etc.) of rotation locking mechanism 1750. For example, rotation locking mechanism 1750 may be fixedly attached to main frame 602 (e.g., vertical rail member 614). When an engagement member(s) 1760 of rotation locking mechanism 1704 engages with an engagement member(s) 1762 of rotation locking mechanism 1750, handle member 1702 is locked and unable to rotate. When an engagement member(s) 1760 of rotation locking mechanism 1704 disengages from an engagement member(s) 1762 of rotation locking mechanism 1750, handle member 1702 is unlocked and free to rotate. Although rotation locking mechanism 1704 is illustrated as a castellated feature on the first end 1730 of handle member 1702 having a plurality of projections separated by slots or notches, rotation locking mechanism 1704 may comprise a single projection or notch as an engagement member 1760 in other embodiments.

With the rotation locking mechanism 1704 of handle member 1702 disengaged from the rotation locking mechanism 1750 of main frame 602, handle member 1702 is free to rotate about rotation axis 1770 as illustrated in FIG. 17E. In an embodiment, handle member 1702 may rotate about rotation axis 1770, between the closed position 1710 and the open position 1712, such as in the range of about 75-105 degrees. With handle member 1702 rotated to the open position 1712, handle member 1702 slides or translates axially (e.g., upward) with the biasing force applied by the biasing member 1706, such as shown in FIG. 17F. This engages the rotation locking mechanism 1704 of handle member 1702 with the rotation locking mechanism 1750 of main frame 602. When engaged, handle member 1702 is locked in the open position 1712. One technical benefit of a handle member 1702 as illustrated in FIGS. 17A-17F is the handle members 1702 of wheelchair transport carrier 600 may be opened to lift wheelchair transport carrier 600, and may be closed for transport so that the shape or size of the wheelchair transport carrier 600 is more compact.

FIG. 18 is a perspective view of wheelchair transport carrier 600 in an illustrative embodiment. In this view, the ramp 662 is in the open position 1204, and the lift handle 612 are in the open position 1712.

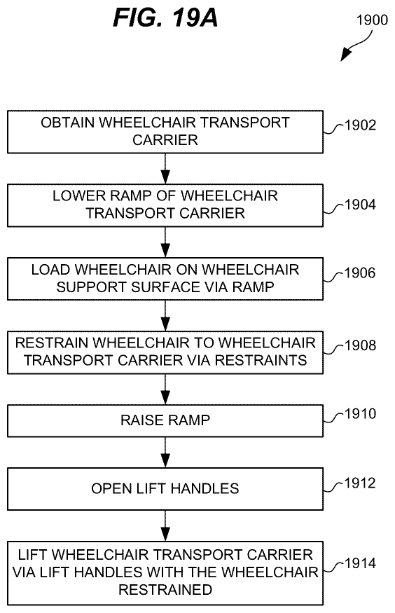

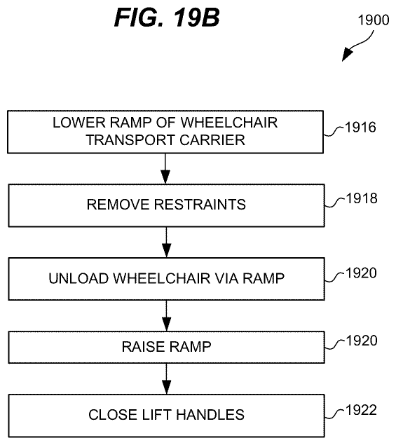

FIGS. 19A-19B are flow charts illustrating a method 1900 of using a wheelchair transport carrier 600 in an illustrative embodiment. The steps of the flow charts described herein are not all inclusive and may include other steps not shown, and the steps may be performed in an alternative order. For method 1900 in FIG. 19A, a wheelchair transport carrier 600 is obtained (step 1902), such as described above, for secure transport of a wheelchair 1402. It is assumed for this embodiment that the wheelchair transport carrier 600 is placed on the ground, a floor, or some other relatively flat surface. The ramp 662 of the wheelchair transport carrier 600 is lowered to the lowered position (step 1904), such as by disengaging the ramp latch(es) 1104 and rotating or pivoting the ramp 662 downward via ramp hinge 1106. With the ramp 662 lowered, a wheelchair 1402 is loaded on the wheelchair support surface 608 of the wheelchair transport carrier 600 via the ramp 662 (step 1906). The wheelchair 1402 is restrained or anchored to the main frame 602 of wheelchair transport carrier 600 via one or more restraints 1610 (step 1908). The ramp 662 is raised to the raised position (step 1910), such as by rotating or pivoting the ramp 662 upward via ramp hinge 1106 and engaging the ramp latch(es) 1104. The lift handles 612 are opened or unfolded to the open position (step 1912), such as by applying a downward force to the handle member 1702 to overcome the biasing force of the biasing member 1706 and disengage the rotation locking mechanism 1704 of handle member 1702 from the corresponding rotation locking mechanism 1750 of main frame 602, rotating the handle member 1702 about rotation axis 1770 to an open position, and releasing the downward force so that the rotation locking mechanism 1704 of handle member 1702 engages the corresponding rotation locking mechanism 1750 of main frame 602. With the lift handles 612 opened, the wheelchair transport carrier 600 may be lifted via the lift handles 612 with the wheelchair 1402 restrained (step 1914), such as onto an aircraft, onto a conveyor, etc. One technical benefit is a wheelchair 1402 may be protected from damage during transport, such as on an aircraft.

After secure transport of the wheelchair 1402, the wheelchair 1402 may be unloaded as follows. For method 1900 in FIG. 19B, the ramp 662 of the wheelchair transport carrier 600 is lowered to the lowered position (step 1916), such as by disengaging the ramp latch(es) 1104 and rotating or pivoting the ramp 662 downward via ramp hinge 1106. The restraints 1610 for the wheelchair 1402 are removed (step 1918), and the wheelchair 1402 is unloaded from the wheelchair transport carrier 600 via the ramp 662 (step 1920). The ramp 662 is raised to the raised position (step 1920), such as by rotating or pivoting the ramp 662 upward via ramp hinge 1106 and engaging the ramp latch(es) 1104. The lift handles 612 are closed or folded to the stowed position (step 1922), such as by applying a downward force to the handle member 1702 to overcome the biasing force of the biasing member 1706 and disengage the rotation locking mechanism 1704 of handle member 1702 from the corresponding rotation locking mechanism 1750 of main frame 602, rotating the handle member 1702 about rotation axis 1770 to a stowed position, and releasing the downward force so that the rotation locking mechanism 1704 of handle member 1702 engages the corresponding rotation locking mechanism 1750 of main frame 602. The wheelchair transport carrier 600 may be stored until a next use.

Although specific embodiments were described herein, the scope of the disclosure is not limited to those specific embodiments. The scope of the disclosure is defined by the following claims and any equivalents thereof.

What is claimed is:

1. A wheelchair transport carrier, comprising:
a main frame comprising a support platform defining a wheelchair support surface to support wheels of a wheelchair;
a plurality of lift handles to lift the main frame; and
a plurality of restraints to anchor the wheelchair to the support platform.

2. The wheelchair transport carrier of claim 1, further comprising:
a ramp at a loading end of the main frame configured to transition between a closed position and an open position.

3. The wheelchair transport carrier of claim 2, further comprising:
a ramp hinge that attaches the ramp to the main frame at the loading end, wherein the ramp is configured to pivot in relation to the main frame about a horizontal rotation axis via the ramp hinge; and
one or more ramp latches configured to secure the ramp in the closed position.

4. The wheelchair transport carrier of claim 1, wherein:
the main frame further comprises a plurality of anchor points for the restraints.

5. The wheelchair transport carrier of claim 4, wherein:
the restraints comprise automatic retractable tie-downs.

6. The wheelchair transport carrier of claim 4, wherein:
the anchor points comprise L-track rails.

7. The wheelchair transport carrier of claim 1, wherein:
the main frame is made from aluminum.

8. The wheelchair transport carrier of claim 1, further comprising:
one or more wheels mounted on a bottom side of the main frame toward an end of the main frame.

9. The wheelchair transport carrier of claim 1, further comprising:
side rails on opposing sides of the main frame.

10. The wheelchair transport carrier of claim 9, further comprising:
a ramp at a loading end of the main frame; and
an end rail on an end of the main frame opposite the loading end.

11. The wheelchair transport carrier of claim 9, wherein:
the side rails comprise one or more horizonal rail members that span at least a portion of a length of the main frame, and a plurality of vertical rail members that connect the one or more horizonal rail members to the support platform.

12. The wheelchair transport carrier of claim 1, wherein:
the lift handles are rotatably coupled to the main frame to transition between a closed position and an open position.

13. The wheelchair transport carrier of claim 12, wherein a lift handle of the lift handles comprises:
a handle member rotatably coupled to a vertical support member of the main frame to rotate about a rotation axis; and
a rotation locking mechanism configured to prevent rotation of the handle member about the rotation axis.

14. The wheelchair transport carrier of claim 13, wherein the lift handle further comprises:
a biasing member configured to apply a biasing force axially in relation to the rotation axis to engage the rotation locking mechanism with a corresponding rotation locking mechanism of the main frame.

15. The wheelchair transport carrier of claim 13, wherein:
the handle member comprises a hollow cylinder and the vertical support member of the main frame is rotatably fitted into the hollow cylinder.

16. The wheelchair transport carrier of claim 13, wherein:
the rotation locking mechanism comprises at least one engagement member configured to engage with at least one corresponding engagement member of a corresponding rotation locking mechanism of the main frame.

17. The wheelchair transport carrier of claim 1, wherein:
a width of the main frame is less than about 31 inches.

18. A wheelchair transport carrier, comprising:
a main frame comprising a support platform defining a wheelchair support surface to support wheels of a wheelchair;
a ramp at a loading end of the main frame configured to rotate in relation to the main frame between a raised position and a lowered position;
a plurality of restraints to anchor the wheelchair to the support platform; and
a plurality of lift handles rotatably coupled to the main frame to transition between a stowed position and an open position.

19. The wheelchair transport carrier of claim 18, wherein a lift handle of the lift handles comprises:
a handle member rotatably coupled to a vertical support member of the main frame to rotate about a rotation axis; and
a rotation locking mechanism configured to lock the handle member in the stowed position or the open position.

20. A method comprising:
obtaining a wheelchair transport carrier comprising:
a main frame comprising a support platform defining a wheelchair support surface to support wheels of a wheelchair;
a ramp at a loading end of the main frame configured to rotate in relation to the main frame between a raised position and a lowered position;
a plurality of restraints to anchor the wheelchair to the support platform; and
a plurality of lift handles rotatably coupled to the main frame to transition between a stowed position and an open position;
lowering the ramp to the lowered position;
loading the wheelchair on the wheelchair support surface via the ramp;
restraining the wheelchair to the main frame via one or more restraints;
raising the ramp to the raised position;
opening the lift handles to the open position; and
lifting the wheelchair transport carrier via the lift handles with the wheelchair restrained.
